(19) United States
(12) Patent Application Publication
(10) Pub. No.: US 2008/0309302 A1
(43) Pub. Date: Dec. 18, 2008

(54) DC-DC CONVERTER

(75) Inventors: Ke-Horng Chen, Taipei County (TW); Hong-Wei Huang, Taichung County (TW); Sy-Yen Kuo, Taipei City (TW); Chi-Chen Chung, Pingtung County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RERSEARCH INSTITUTE, Hsinchu (TW)

(21) Appl. No.: 11/965,512

(22) Filed: Dec. 27, 2007

(30) Foreign Application Priority Data
Jun. 15, 2007 (TW) TW96121711

(51) Int. Cl. G05F 1/00

(52) U.S. Cl. 323/282

(57) ABSTRACT

The invention discloses DC-DC converters comprising an inductance, a pulse width modulator generating a pulse signal according to the voltage level of a transformed voltage output terminal, a load sensor sensing a load current, an adaptive enable signal generator generating a PMOS transistor enable signal and an NMOS transistor enable signal based on the pulse signal and the load current, and a power transistor set comprising at least one PMOS transistor and an NMOS transistor. The power transistor set is used in coupling the transformed voltage output terminal to an original DC voltage source or ground via the inductance. The conductance of the PMOS and NMOS transistors are controlled by the PMOS and NMOS transistor enable signals, respectively. The adaptive enable signal generator makes a first dead-time between the PMOS and NMOS transistor enable signals decreasing with increasing load current.

### BACKGROUND OF THE INVENTION

1. Field of the Invention

The present invention relates to DC-DC converters.

2. Description of the Related Art

The size of portable electronic devices shrinks along with new system on chip (SOC) development techniques. Shrinkage however, is limited to the size and power output of batteries. Normally, a battery with high power output and high density is too expensive to be applied in consumer portable electronic products. Nevertheless, to extend useful life of batteries and electronic devices, the invention discloses DC-DC converters with minimal power dissipation. The DC-DC converters are used in transforming the battery voltage into operating voltage of electronic devices. The useful life of the battery can be efficiently extended if unnecessary power dissipation and noise of the DC-DC converter can be eliminated.

FIG. 1 illustrates a conventional DC-DC converter using a conventional pulse width modulation technique. The power transistor set of the conventional DC-DC converter comprises a PMOS transistor Mₚ and an NMOS transistor Mₙ. The conductance of Mₚ and Mₙ are controlled by a pulse signal 102. The pulse width of the pulse signal 102 varies with the voltage level of a transformed voltage output terminal of the DC-DC converter (Vₒᵤₜ). At the moment the pulse signal 102 switches the state of the transistors Mₚ and Mₙ, such as turning on Mₚ and turning off Mₙ, or turning off Mₚ and turning on Mₙ, a large current suddenly flows from the original DC voltage source Vᵢₙ to the ground via the transistors Mₚ and Mₙ. The large current results in large power dissipation. One solution to prevent the large current flow is to stagger the switching moment of Mₚ and Mₙ. For this solution, instead of providing a single pulse signal 102, a PMOS transistor enable signal SW_P is provided to control the conductance of the PMOS transistor Mₚ and an NMOS transistor enable signal SW_N is provided to control the conductance of the NMOS transistor Mₙ. The time period between when the moment Mₚ is turned off and the moment Mₙ is turned on is named a first dead-time. The time period between when the moment Mₚ is turned on and the moment Mₙ is turned off is named a second dead-time.

The lengths of the first and second dead-times have to be carefully designed. If the dead-time is too short, the aforementioned large current will still exist. If the dead-time is too long, a body diode conduction effect is caused. FIG. 2 shows how the PMOS transistor enable signal SW_P and the NMOS transistor enable signal SW_N affect the voltage level of a first terminal (Vₓ) shown in FIG. 1. In this example, the length of the first dead-time 206 is fixed. During the first dead-time 206, the descent speed of Vₓ is dependent on the load of the DC-DC converter. Waveform 202 shows the waveform of Vₓ when the DC-DC converter is in light load. Waveform 204 shows the waveform of Vₓ when the DC-DC converter is in heavy load. Comparing the waveforms 202 and 204, the descent speed of waveform 202 (light load) is slower than the descent speed of waveform 204 (heavy load). In the light load case, Mₙ is turned on too early so that the parasitic electric charges at the first terminal leaks to the ground via Mₙ. In the heavy load case, the NMOS transistor Mₙ is turned on too late and it results in body diode conduction. The invention discloses techniques providing an adaptive first dead-time varying with the load of the DC-DC converter.

FIG. 3 shows waveforms of Vₓ, SW_P and SW_N to explain ground bounce ripple. Symbols 306 and 308 indicate the body diode conduction generated by improper first and second dead-times 302 and 304. Furthermore, there is ground bounce ripple (indicated by 310) occurring at the moment the PMOS transistor enable signal SW_P turns on the PMOS transistor Mₚ. The invention further provides a technique to avoid the ground bounce ripple.

### BRIEF SUMMARY OF THE INVENTION

The invention discloses DC-DC converters. The DC-DC converter comprises an inductance, a pulse width modulator, a load sensor, an adaptive enable signal generator, and a power transistor set. The pulse width modulator generates a pulse signal according to the voltage level of a transformed voltage output terminal of the DC-DC converter. The load sensor senses a load current of the DC-DC converter. The adaptive enable signal generator generates a PMOS transistor enable signal and an NMOS transistor enable signal based on the pulse signal and the load current. A first dead-time between the PMOS and NMOS transistor enable signals decreases with increasing load current. The power transistor set comprises at least one PMOS transistor and an NMOS transistor, and is used in coupling the transformed voltage output terminal to an original DC voltage source or ground via the inductance. The conductance of the PMOS transistor is controlled by the PMOS transistor enable signal, and the conductance of the NMOS transistor is controlled by the NMOS transistor enable signal.

In some embodiments, there are more than one PMOS transistors in the power transistor set, which are coupled in parallel. In these cases, the DC-DC converter further comprises a ground bounce ripple reducer. To reduce the ground bounce ripple, instead of turning on all PMOS transistors at one time, the ground bounce ripple reducer gradually increases the PMOS transistor conduction area of the PMOS transistors in several stages, wherein the PMOS transistor conduction area in each stage is dependent on the load current of the DC-DC converter.

The above and other advantages will become more apparent with reference to the following description taken in conjunction with the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates a conventional DC-DC converter using a conventional pulse width modulation technique;

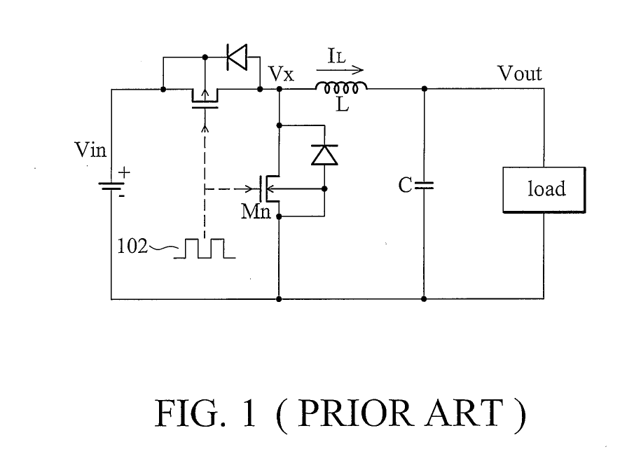

FIG. 2 shows how the PMOS and NMOS transistor enable signals SW_P and SW_N affect Vₓ shown in FIG. 1;

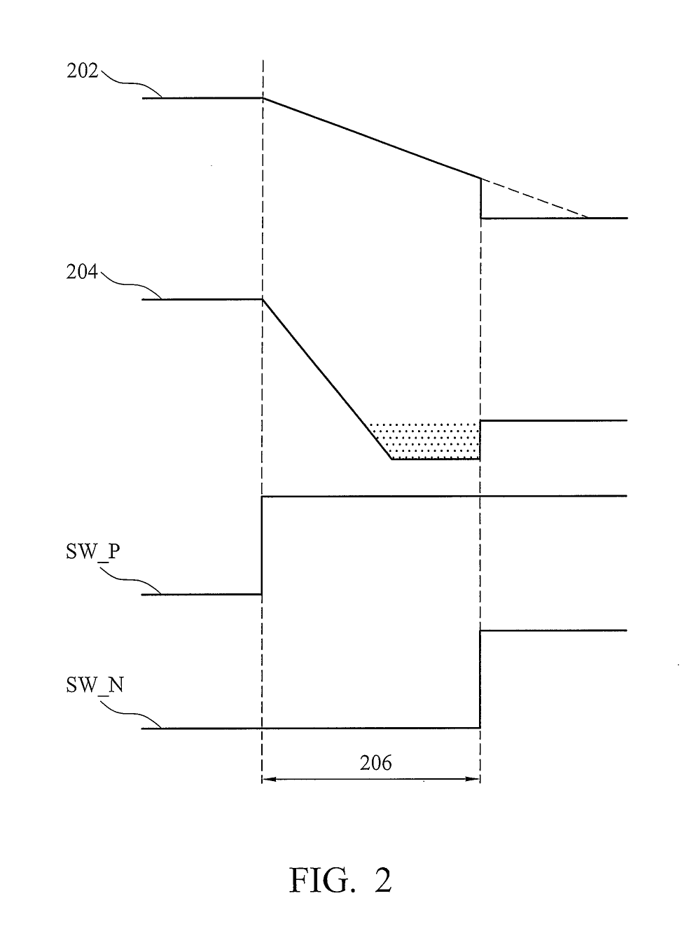

FIG. 3 shows waveforms of Vₓ, SW_P and SW_N to explain ground bounce ripple;

FIG. 4 illustrates an embodiment of the DC-DC converter of the invention;

FIG. 5 illustrates an embodiment of the adaptive enable signal generator of the invention;

FIG. 6 illustrates an embodiment of the load sensor of the invention;

FIG. 7 shows an embodiment of the current driving delay circuit of the invention;

FIG. 8 is a flow chart describing how the first current source calibrator of the invention calibrates the first current source I_{B};

FIG. 9 shows the waveforms of Vₓ in heavy load, Vₓ in light load and SW_P;

FIG. 10 illustrates an embodiment of the DC-DC converter of the invention, which is capable of reducing the ground bounce ripple;

FIG. 11 illustrates an embodiment realizing the ground bounce ripple reducer 1002, the driving circuit 1004 and the PMOS transistors Mₚ₁˜M_{pN} shown in FIG. 10;

FIG. 12 illustrates another embodiment of the DC-DC converter of the invention.

### DETAILED DESCRIPTION OF THE INVENTION

The following description shows some embodiments carrying out the invention. This description is made for the purpose of illustrating the general principles of the invention and should not be taken in a limiting sense. The scope of the invention is best determined by reference to the appended claims.

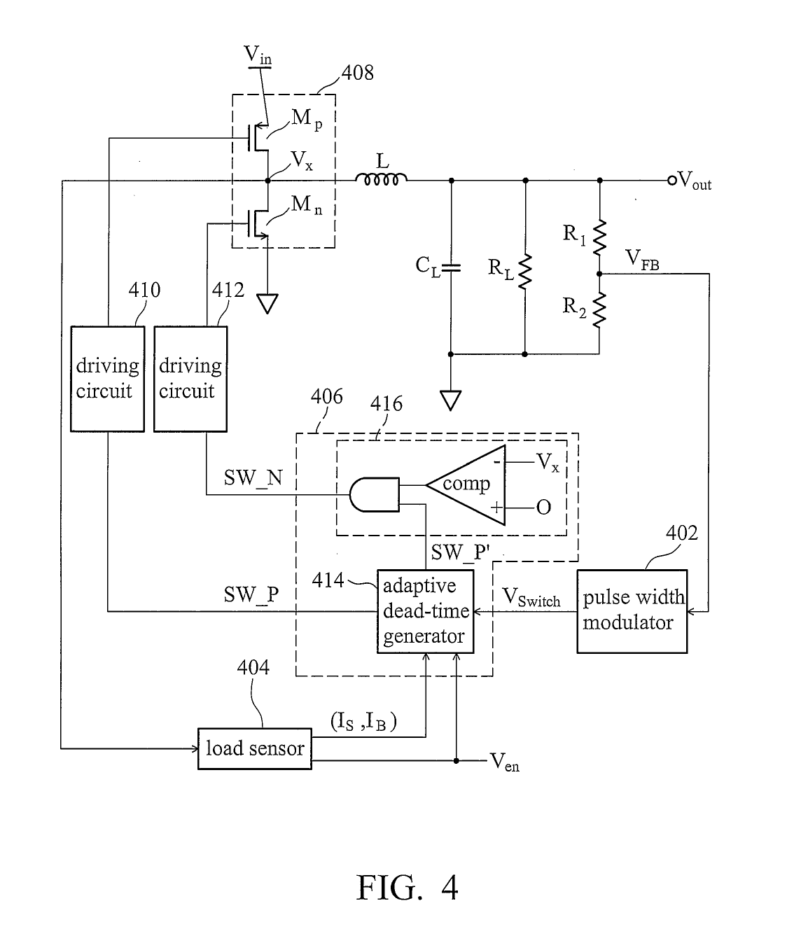

FIG. 4 illustrates an embodiment of the DC-DC converter of the invention, comprising an inductance L, a pulse width modulator 402, a load sensor 404, an adaptive enable signal generator 406 and a power transistor set 408. The voltage level of the transformed voltage output terminal of the DC-DC converter is Vₒᵤₜ. The resistors R₁ and R₂, coupled in series, divide Vₒᵤₜ to generate a feedback voltage V_{FB}. V_{FB} is inputted to the pulse width modulator 402 for generating a pulse signal V_{switch}. The pulse width of the pulse signal V_{switch} is dependent on V_{FB} and V_{FB} is dependent on Vₒᵤₜ. The load sensor 404 senses the load current of the DC-DC converter and transmits the sensed value to the adaptive enable signal generator 406. The adaptive enable signal generator 406 generates a PMOS transistor enable signal and an NMOS transistor enable signal according to the pulse signal V_{switch} and the load current. The adaptive enable signal generator 406 makes a first dead-time between the PMOS and NMOS transistor enable signals decrease with increasing load current. In the case shown in FIG. 4, the power transistor set 408 comprises one PMOS transistor Mₚ and one NMOS transistor Mₙ. When Mₚ is turned on, the transformed voltage output terminal is coupled to an original DC voltage source Vᵢₙ via the inductance L. When Mₙ is turned on, the transformed voltage output terminal is coupled to ground via the inductance L. The conductance of the PMOS and NMOS transistors Mₚ and Mₙ are controlled by the PMOS and NMOS transistor enable signals SW_P and SW_N, respectively. In this case, the PMOS transistor enable signal SW_P is coupled to the gate of the PMOS transistor Mₚ via a driving circuit 410, and the NMOS transistor enable signal SW_N is coupled to the gate of the NMOS transistor Mₙ via a driving circuit 412. When SW_P is in its enable state (low voltage level), the driving circuit 410 pulls the voltage level of the gate of Mₚ down toward the ground to completely turn on Mₚ. When SW_N is in its enable state (high voltage level), the driving circuit 412 pulls the voltage level of the gate of Mₙ up towards the voltage level of the original DC voltage source Vᵢₙ to completely turn on Mₙ.

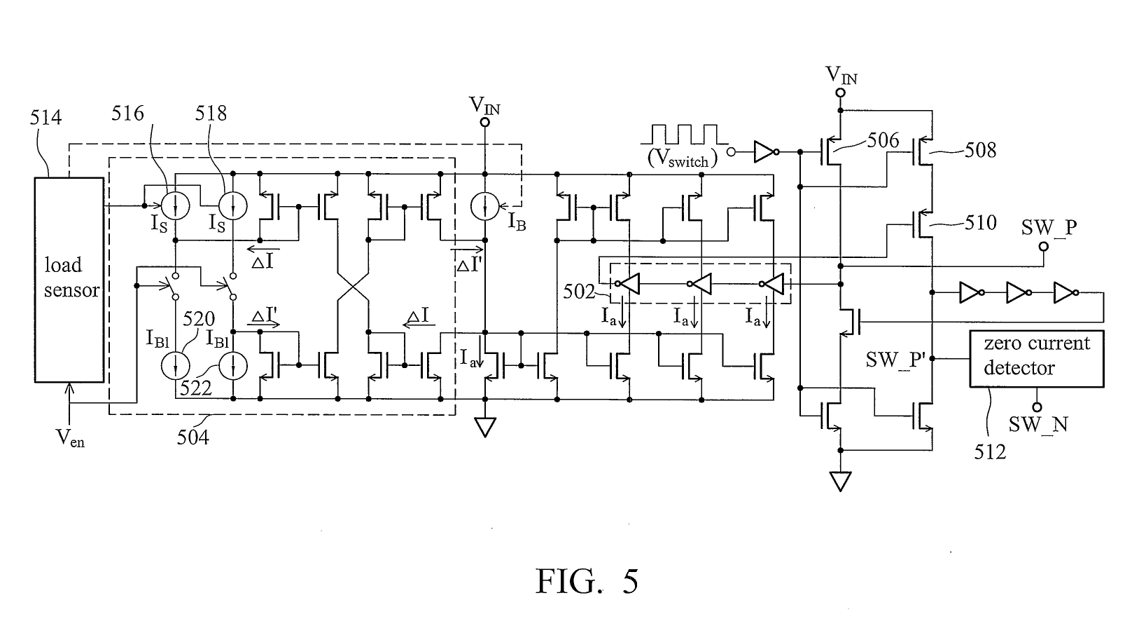

Referring to FIG. 4, the adaptive enable signal generator 406 comprises an adaptive dead-time generator 414 and a zero current detector (ZCD) 416. FIG. 5 illustrates an embodiment of the adaptive enable signal generator 406, comprising a first dead-time controller 502, a first current source I_{B} and a current compensation circuit 504. The first dead-time controller 502 controls the length of the first dead-time and comprises a plurality of inverters that are coupled in series. Every inverter is driven by a first driving current Iₐ. When detecting the rising edge of the PMOS transistor enable signal SW_P, the first dead-time controller 502 outputs a signal to trigger the NMOS transistor enable signal SW_N to rise. In this embodiment, when the pulse signal V_{switch} is at high level, the transistors 506 and 508 are turned on to pull the PMOS transistor enable signal SW_P to the high level. When SW_P is at high level, the first dead-time controller 502 outputs a signal at low level so that the gate of the transistor 510 is at low level. Thus, the transistor 510 is turned on to pull an NMOS transistor reference enable signal SW_P′ to high level. When detecting the rising SW_P′, the zero current detector 512 outputs a rising NMOS transistor enable signal SW_N. It is obvious that the time difference between the rising edge of SW_P and the rising edge of SW_N (aka the first dead-time) is dependent on the transmission speed of the inverters of the first dead-time controller 502. The faster the transmission speed of the inverters is, the shorter the first dead-time is. Because the transmission time of the inverters is inverse proportional to their driving current (Iₐ), the length of the first dead-time decreases with increasing Iₐ.

The following description describes the relationship between the first driving current Iₐ and the load current of the DC-DC converter. The main source of the first driving current Iₐ is the first current source I_{B} and the current compensation circuit 504. The current compensation circuit 504 is enabled by a compensation enable signal Vₑₙ, and is used in generating a compensating current (ΔI′ or −ΔI) according to the load current of the DC-DC converter. The compensation enable signal Vₑₙ is controlled by a soft start circuit (not shown in the figure). When a soft start procedure is executed, the soft start circuit shuts down the current compensation circuit 504 via the compensation enable signal Vₑₙ. Thus the first current source I_{B} is the only source of the first driving current Iₐ. When the soft start procedure is ended, the soft start circuit enables the current compensation circuit 504 via the compensation enable signal Vₑₙ. Thus the first driving current Iₐ equals the sum of the first current source I_{B} and the compensating current (ΔI′ or −ΔI). The compensating current (ΔI′ or −ΔI) makes the first driving current Iₐ proportional to the load current of the DC-DC converter. Referring to the circuit shown in FIG. 5, the first driving current Iₐ increases with increasing load current and the transmission speed of the inverters of the first dead-time controller 502 increases with increasing Iₐ, so that the greater the load current of the DC-DC converter is, the shorter the first dead-time is. The adaptive enable signal generator, therefore, provides a proper first dead-time avoiding the large current from Vᵢₙ to ground and the body diode conduction.

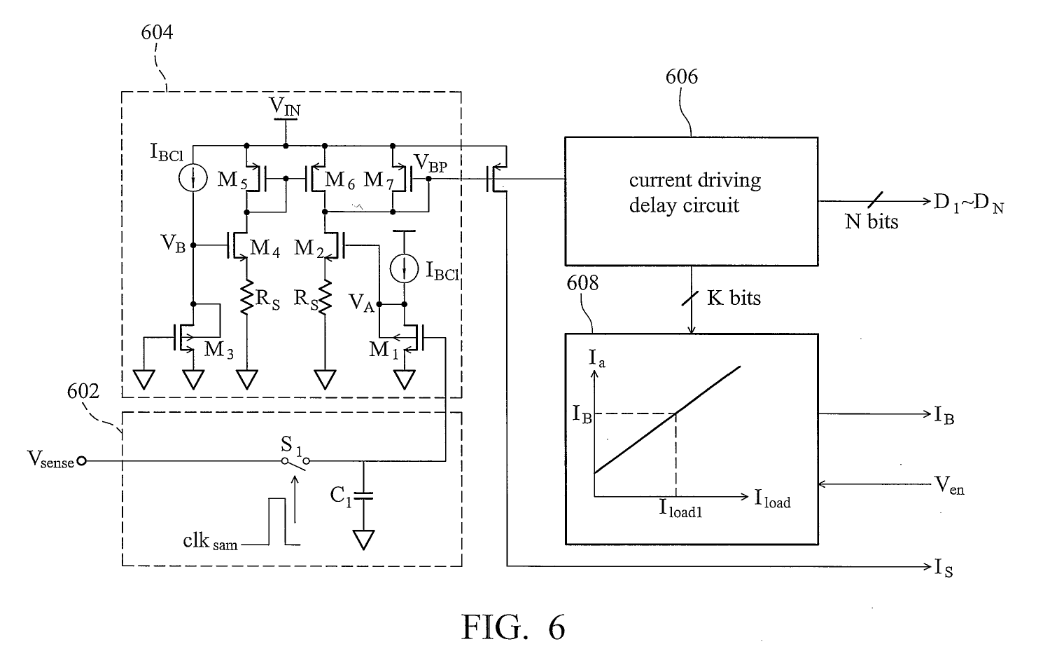

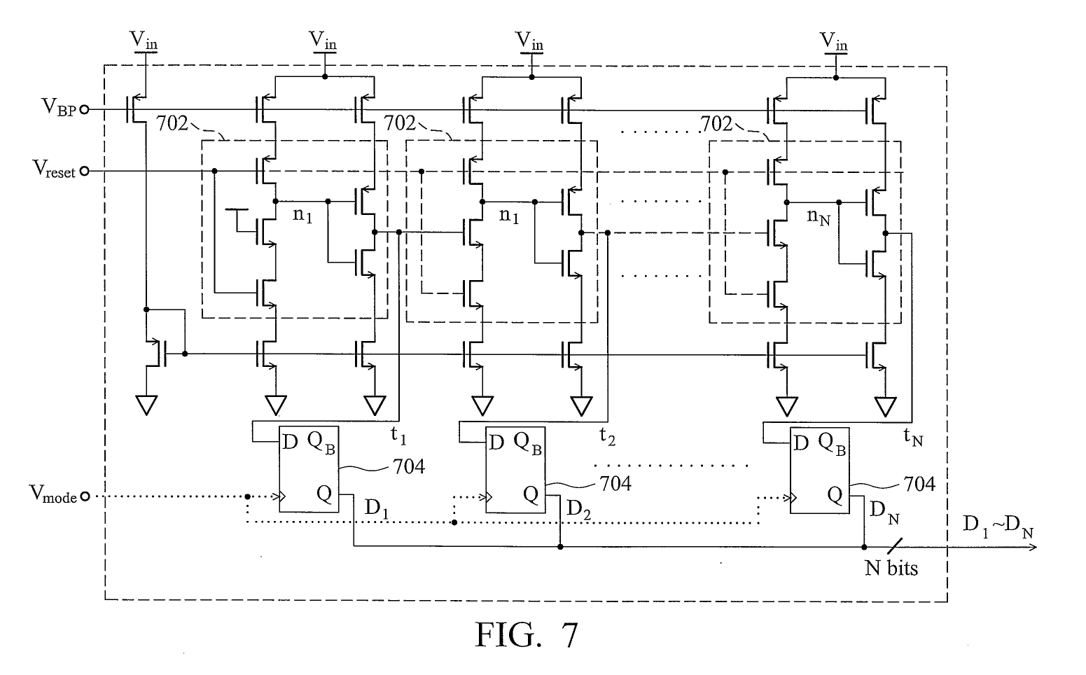

FIG. 6 illustrates an embodiment of the load sensor of the invention, comprising a sensed voltage generator (not shown in FIG. 6), a sample and hold circuit 602, a voltage-current transformer 604, a current driving delay circuit 606 and a first current source calibrator 608. The sensed voltage generator is used in generating a sensed voltage Vₛₑₙₛₑ proportional to the load current of the DC-DC converter. The sensed voltage Vₛₑₙₛₑ is sampled by the sample and hold circuit 602 and then transformed to a second driving current Iₛ by the voltage-current transformer 604. FIG. 7 shows an embodiment of the current driving delay circuit of the invention, comprising a plurality of delay cells 702 and a plurality of D flip-flops 704. The delay cells 702 are implemented by inverters. The inverters are coupled in series and each of them is driven by the second driving current Iₛ generated by the voltage-current transformer 604. During a sample period, a reset signal Vᵣₑₛₑₜ rises from low to high and is transmitted by the delay cells 702. The D flip-flops 704 have a one-to-one relationship with the delay cells 702 and are all triggered by an access signal V_{mode} to retrieve the signals at the output terminals of the delay cells 702. Digital signals D₁˜D_{N} represent the signals retrieved by the D flip-flops 704. Because the second driving current Iₛ is proportional to the load current of the DC-DC converter, the transmission speed of the inverters driven by Iₛ increases with increasing load current. The larger second driving current Iₛ is, the faster the digital signals D₁˜D_{N} rise to the high level. Thus, the magnitude of the load current of the DC-DC converter can be determined according to the status of the digital signals D₁˜D_{N}. At a decision-making moment, the more the digital signals (D₁˜D_{N}) are at high level, the greater the load current is. Referring to FIG. 6, all of the digital signals D₁˜D_{N} or k bits of D₁˜D_{N} are sent into the first current source calibrator 608. The first current source calibrator 608 calibrates the first current source after the soft start procedure and before the compensation enable signal Vₑₙ enables the current compensation circuit 504. The calibrated I_{B} makes the DC-DC converter have the most suitable first dead-time at a reference load current I_{load1}.

Referring to FIG. 5, after the first current source calibration procedure, the current compensation circuit 504 is enabled by the compensation enable signal Vₑₙ. The load sensor 514 drives the variable current sources 516 and 518 to copy Iₛ generated by the voltage-current transformer 604. As shown in FIG. 5, the current compensation circuit 504 further comprises two current sources 520 and 522 outputting constant current I_{B1}. The value of I_{B1} equals to the Iₛ corresponding to the reference load current I_{load1}. In a case where the actual load current is greater than the reference load current I_{load1}, Iₛ is greater than I_{B1} and only the variable current source 518 and the current source 522 are active so that the compensating current generated by the current compensation circuit 504 is ΔI′ (=Iₛ−I_{B1}) and the first driving current Iₐ is I_{B}+ΔI′ (=I_{B}+Iₛ−I_{B1}). In a case where the actual load current is less than the reference load current I_{load1}, Iₛ is less than I_{B1} and only the variable current source 516 and the current source 520 are active so that the compensating current generated by the current compensation circuit 504 is −ΔI (=Iₛ−I_{B1}) and the first driving current Iₐ is I_{B}−ΔI (=I_{B}+Iₛ−I_{B1}). To summarize, Iₐ=I_{B}+Iₛ−I_{B1}. Because I_{B} and I_{B1} are fixed, the first driving current Iₐ is proportional to the second driving current Iₛ. Because the second driving current Iₛ is proportional to the load current of the DC-DC converter, the first driving current Iₐ is proportional to the load current of the DC-DC converter. To sum up the actions of the adaptive enable signal generator shown in FIG. 5, the greater the load current of the DC-DC converter is, the greater the first driving current Iₐ is, the faster the transmission speed of the first dead-time control circuit 502 is, the shorter the length of the first dead-time is. The length of the first dead-time decreases with increasing load current so that the large conduction current from Vᵢₙ to ground by the invention. In some embodiments, process deviation may affect the precision of the variable current sources 516 and 518 and the current sources 520 and 522. The precision problem can be solved by the first current source calibrator 608 during the I_{B} calibration procedure.

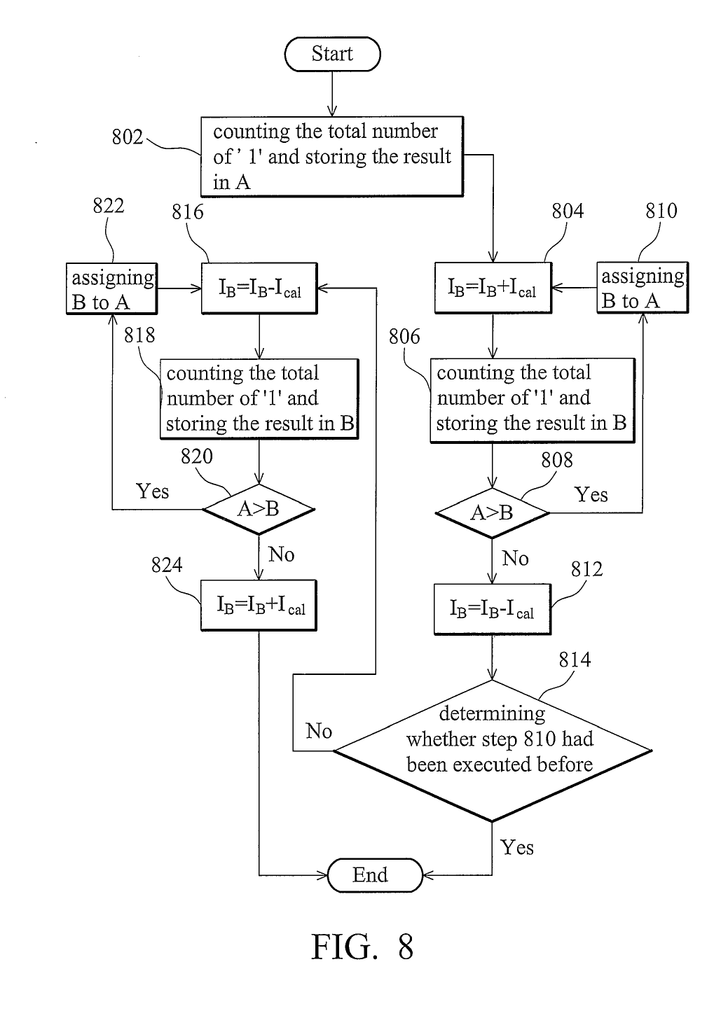

FIG. 8 is a flow chart describing how the first current source calibrator of the invention calibrates the first current source I_{B}. The calibration is based on the amount of ‘1’ of the digital signals D₁˜D_{N}. In a situation having an improper first dead-time, there is large power dissipation in the DC-DC converter and the operating period of the pulse signal V_{switch} is increased so that the sensed voltage Vₛₑₙₛₑ increases and the amount of ‘1’ between D₁˜D_{N} increases. The object of the calibration is to find a proper I_{B} making the fewest amount of ‘1’ between D₁˜D_{N}. Referring to FIG. 8, at the beginning of the calibration, the DC-DC converter is at the reference load current I_{load1}. In step 802, the amount of ‘1’ between D₁˜D_{N} is stored in a resistor A. In step 804, I_{B} is positively adjusted by I_{cal}. In step 806, the amount of ‘1’ between D₁˜D_{N} is checked again and the result is stored in a resistor B. In step 808, A is compared with B to check if the positive adjustment in step 804 is correct. When A>B, it represent the positive adjustment is correct and the next step is step 810, which assigns B to A for the next positive adjustment (step 804). When B>A in step 808, it represents that the positive adjustment in step 804 is incorrect and the method executes step 812 to recover the value of I_{B}. The method then executes step 814 to check if step 810 had been executed before. If step 810 had been executed, it means that the ideal value of I_{B} is greater than the initial value of I_{B}, and the present I_{B} is close to the ideal value and the calibration can be ended. If step 810 had not been executed, it means that the ideal value of I_{B} is less than the initial value of I_{B} and a negative adjustment is required. The method then executes steps 816-824 to get a proper I_{B}.

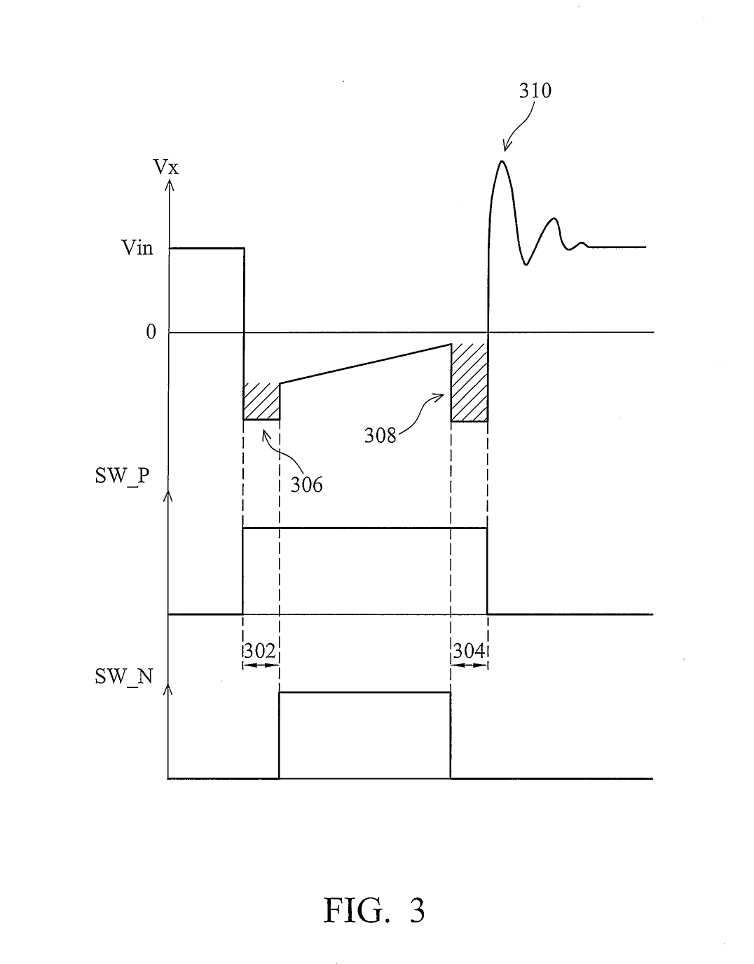

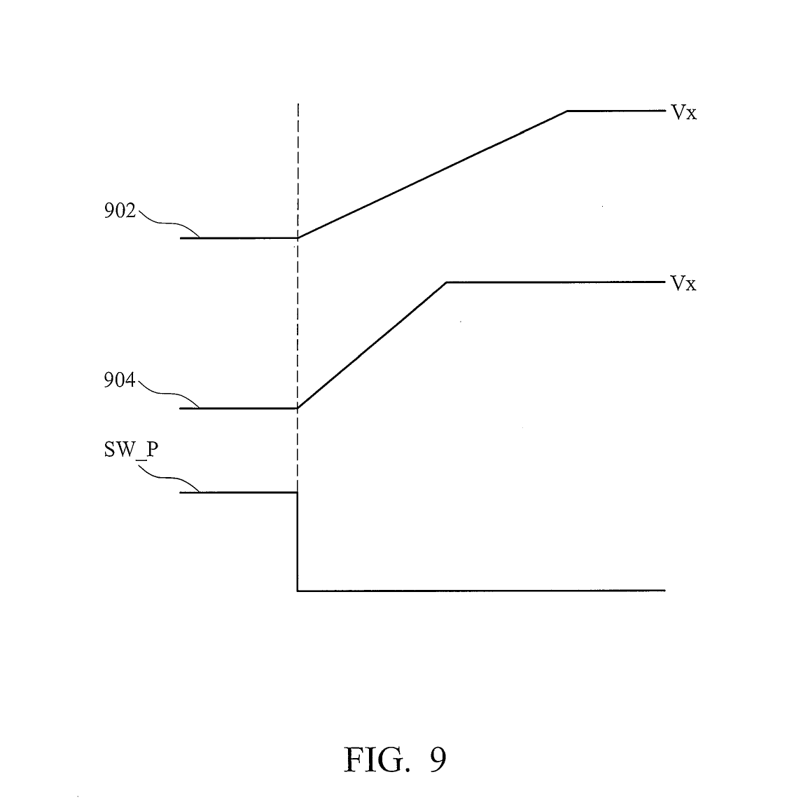

The invention further discloses techniques for reducing ground bounce ripple. In a case where the power transistor set has a large sized PMOS transistor, when the PMOS transistor is suddenly turned on, the original DC voltage source Vᵢₙ generates a large current and a ground bounce ripple (such as that indicated by symbol 310 of FIG. 3) is generated. The voltage level of the first terminal (Vₓ) starts oscillating and may be greater than the voltage value of the original DC voltage source Vᵢₙ. To reduce the ground bounce ripple, the invention discloses techniques that replace the large sized PMOS transistor by a plurality of small sized PMOS transistors. The invention controls the conductance of the small sized PMOS transistors to gradually increase the PMOS transistor conduction area. Therefore, instead of a large current, the original DC voltage source Vᵢₙ provides small current to raise the voltage level of the first terminal (Vₓ) and the ground bounce ripple is reduced. However, the rising speed of Vₓ is dependent on the load current of the DC-DC converter. FIG. 9 shows the waveforms of the voltage level of the first terminal (Vₓ) and the PMOS transistor enable signal SW_P. Waveform 902 shows the voltage level of the first terminal Vₓ when the DC-DC converter is in heavy load. In the heavy load case, because majority of the current from the power transistor set is drawn by the load via the inductance L, the voltage level of the first terminal Vₓ rises slowly. Waveform 904 shows the voltage level of the first terminal (Vₓ) when the DC-DC converter is in light load. In the light load case, because majority of the current from the power transistor set is stored in the parasitic capacitor of the first terminal, the voltage level of the first terminal Vₓ rises quickly. Therefore, in addition to gradually increasing the PMOS transistor conduction area, the PMOS transistor conduction areas in different stages are determined according to the load current of the DC-DC converter.

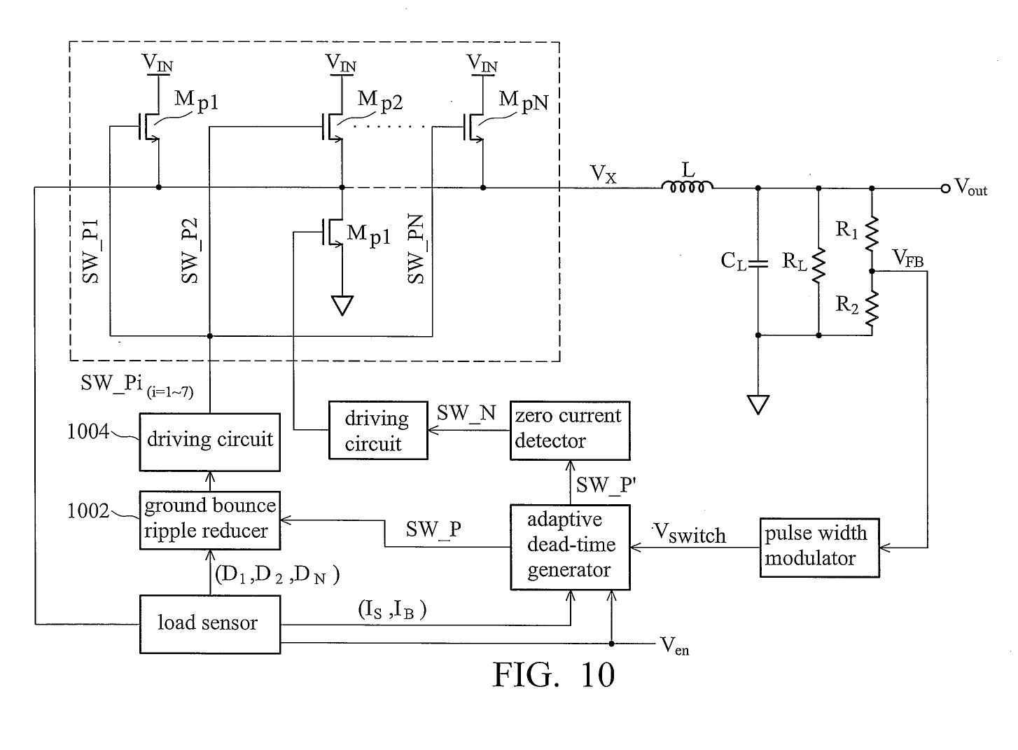

FIG. 10 illustrates an embodiment of the DC-DC converter of the invention, which is capable of reducing the ground bounce ripple. Compared to FIG. 4, the embodiment shown in FIG. 10 replaces the PMOS transistor Mₚ of FIG. 4 with a plurality of small sized PMOS transistors Mₚ₁˜M_{pN}. The PMOS transistors Mₚ₁˜M_{pN} are coupled in parallel between the original DC voltage source Vᵢₙ and the first terminal Vₓ. In addition to the components shown in FIG. 4, FIG. 10 further comprises a ground bounce ripple reducer 1002. The ground bounce ripple reducer 1002 is used in controlling the conductance of the small sized PMOS transistors Mₚ₁˜M_{pN} to gradually increase the PMOS transistor conduction area, and is used in determining the PMOS transistor conduction areas in different stages according to the load current of the DC-DC converter. In this case, the circuit of the driving circuit 1004 is designed to separately control the PMOS transistors Mₚ₁˜M_{pN}.

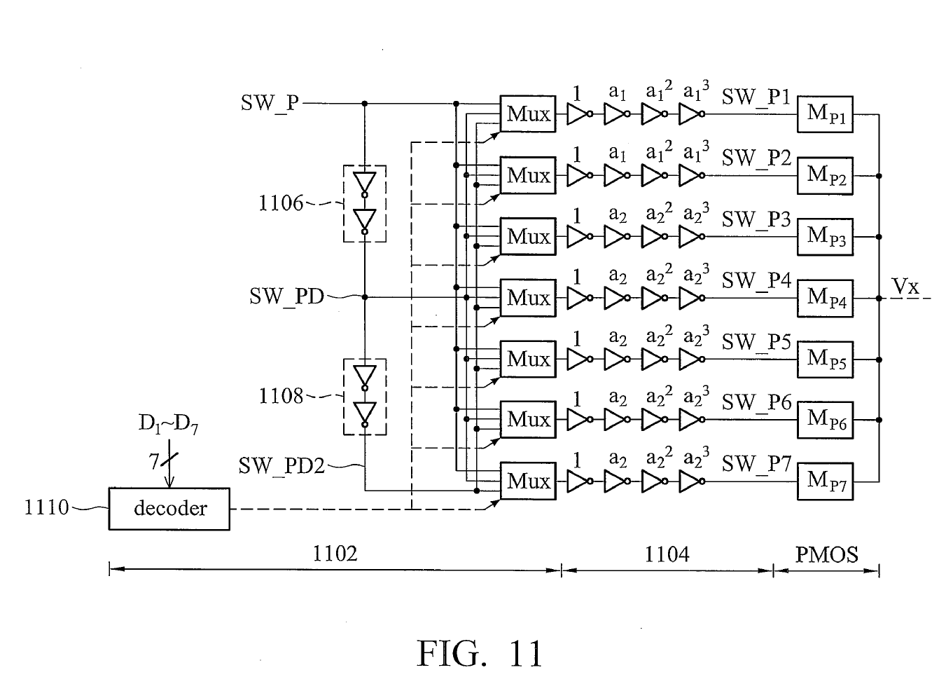

FIG. 11 illustrates an embodiment realizing the ground bounce ripple reducer 1002, the driving circuit 1004 and the PMOS transistors Mₚ₁˜M_{pN}. In this case, there are seven PMOS transistors Mₚ₁˜Mₚ₇. The ground bounce ripple reducer 1102 comprises two delay circuits 1106 and 1108, seven multiplexers Mux having a one-to-one relationship with the PMOS transistors Mₚ₁˜Mₚ₇, and a decoder 1110. This case gradually increases the PMOS transistor conduction area in three stages. The delay circuits 1106 and 1108 are used in delaying the PMOS transistor enable signal SW_P to generate the delayed PMOS transistor enable signals SW_PD and SW_PD2. The PMOS transistors Mₚ₁˜Mₚ₇ may be turned on by SW_P, SW_PD or SW_PD2, and is dependent on the selection signals generated by the decoder 1110. After receiving the digital signals D₁˜D_{N} representing the magnitude of the load current of the DC-DC converter, the decoder 1110 generates selection signals dependent on the load current to determine how to turn on the PMOS transistors Mₚ₁˜Mₚ₇ in the three stages. Based on the selection signals, the multiplexers Mux each select one of the enable signals SW_P, SW_PD and SW_PD2 to drive their corresponding PMOS transistors Mₚ₁˜Mₚ₇. The PMOS transistor conduction area is gradually increased in three stages.

The invention provides an embodiment wherein the size of the PMOS transistors Mₚ₁˜Mₚ₇ are x1, x1, x2, x2, x2, x2 and x2, and the load of the DC-DC converter can be classified as light load, middle load and heavy load. The load current in middle load is three times the load current in light load, and the load current in heavy load is five times the load current in middle load. When the DC-DC converter is in light load, the three different stages of PMOS transistor conduction areas are x1, x6 and x12, respectively. When the DC-DC converter is in middle load, the three different stages of PMOS transistor conduction areas are x3, x7 and x12, respectively. When the DC-DC converter is in heavy load, the three different stages of PMOS transistor conduction areas are x5, x8 and x12, respectively. The invention can efficiently reduce the ground bounce ripple.

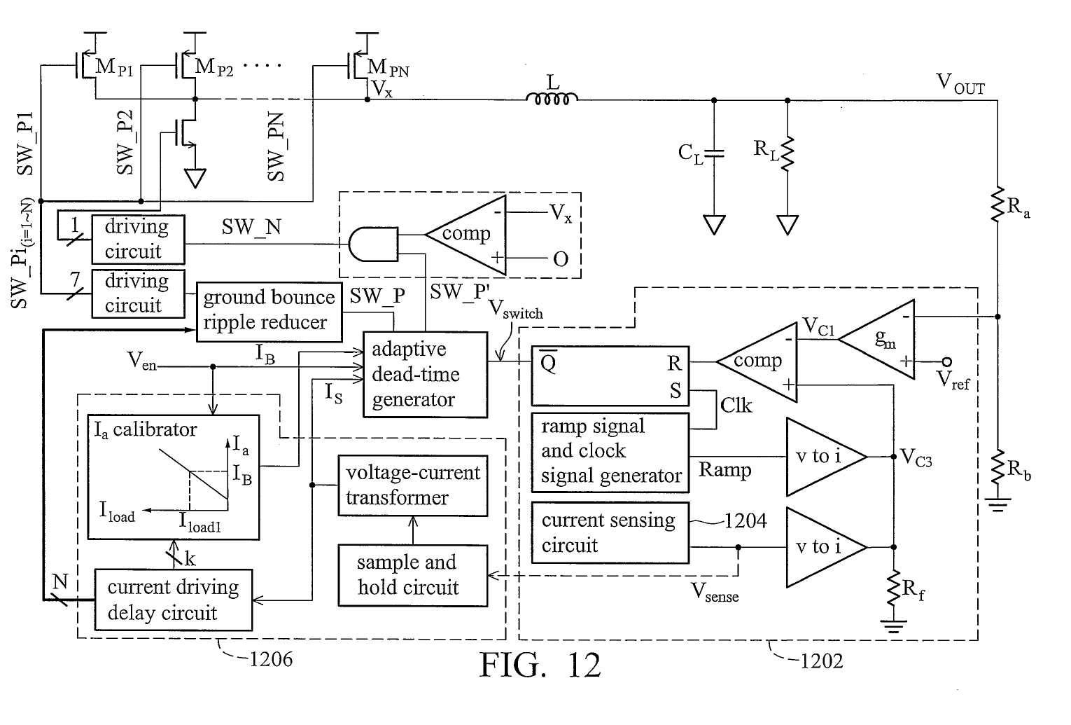

FIG. 12 illustrates another embodiment of the DC-DC converter of the invention, which is capable of providing adaptive first dead-time and reducing ground bounce ripple. In this case, the current sensing circuit 1204 provides the load sensor 1206 with the sensed voltage Vₛₑₙₛₑ.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded to the broadest interpretation so as to encompass all such modifications and similar arrangements.

What is claimed is:

1. A DC-DC converter, comprising:
an inductance;
a pulse width modulator, generating a pulse signal based on the voltage level of a transformed voltage output terminal of the DC-DC converter;
a load sensor, sensing a load current of the DC-DC converter;
an adaptive enable signal generator, generating a PMOS transistor enable signal and an NMOS transistor enable signal based on the pulse signal and the load current, wherein a first dead-time between the PMOS and NMOS transistor enable signals decreases with increasing load current; and
a power transistor set, comprising at least one PMOS transistor and an NMOS transistor to couple the transformed voltage output terminal to an original DC voltage source or ground, wherein the conductance of the PMOS transistor and the NMOS transistor are controlled by the PMOS and the NMOS transistor enable signals, respectively.

2. The DC-DC converter as claimed in claim 1, wherein the adaptive enable signal generator comprises:
a first dead-time control circuit, composed of a plurality of inverters coupled in series and driven by a first driving current, and outputting a signal to trigger the NMOS transistor enable signal to rise from low to high when detecting the rise of the PMOS transistor enable signal;
a first current source; and
a current compensation circuit, enabled by a compensation enable signal to output a compensating current based on the load current;
wherein the first driving current is provided by the first current source when the current compensation circuit is disabled, and is provided by both the first current source and the current compensation circuit when the current compensation circuit is enabled, and the compensating current making the first driving current proportional to the load current.

3. The DC-DC converter as claimed in claim 2, wherein the load sensor comprises:
a sensed voltage generator, generating a sensed voltage proportional to the load current;
a sample and hold circuit, sampling the sensed voltage;
a voltage-current transformer, transforming the sensed voltage into a second driving current;
a current driving delay circuit, comprising:
a plurality of delay cells, composed of a plurality of inverters coupled in series and each is driven by the second driving signal to transmit a high level signal; and
a plurality of D-flip-flops, having a one-to-one relationship with the delay cells, all triggered by an access signal to retrieve the signals at the output terminals of the delay cells to generate a plurality of digital signals; and
a first current source calibrator, calibrating the first current source before the current compensation circuit is enabled to optimize the first dead-time at a reference load current.

4. The DC-DC converter as claimed in claim 3, wherein the compensating current equals to the current difference between the second driving current and the current from a second current source, and the second current source outputs a constant current whose value equals to the current outputted from the voltage-current transformer as the DC-DC converter is at the reference load current.

5. The DC-DC converter as claimed in claim 4, wherein the first current source calibrator further comprises the following processes before the current compensation circuit is enabled:
initializing the load current as the reference load current;
counting the digital signals at high level;
calibrating the first current source and recounting the digital signals at high level; and
stopping to calibrate the first current source once the fewest digital signals are reached at high level.

6. The DC-DC converter as claimed in claim 1, wherein the power transistor set comprises more than one PMOS transistors that are coupled in parallel and are used in coupling the transformed voltage output terminal to the original DC voltage source.

7. The DC-DC converter as claimed in claim 6, further comprising a ground bounce ripple reducer controlling the conductance of the PMOS transistors to gradually increase a PMOS transistor conduction area, wherein the PMOS transistor conduction areas in different stages are determined according to the load current.

8. The DC-DC converter as claimed in claim 7, wherein the ground bounce ripple reducer comprises:
a plurality of delay circuits, delaying the PMOS transistor enable signal to generate a plurality of delayed PMOS transistor enable signals;
a plurality of multiplexers, having a one-to-one relationship with the PMOS transistors, wherein the input terminals of each of the multiplexers are coupled to the PMOS transistor enable signal and the delayed PMOS transistor enable signals; and
a decoder, generating selection signals for the multiplexers according to the load current sensed by the load sensor.

9. The DC-DC converter as claimed in claim 8, wherein the PMOS transistor conduction area in the first stage increases with increasing load current.
